(19) United States
(12) Patent Application Publication
(10) Pub. No.: US 2004/0178369 A1
(43) Pub. Date: Sep. 16, 2004

(54) Device for processing substrates, especially electrical circuit substrates, with a laser

(76) Inventors: Axel Brock, Errlingen (DE); Stefan Loeffler, Kaempfelbach (DE)

Correspondence Address: HARNESS, DICKEY & PIERCE, P.L.C., P.O.BOX 8910, RESTON, VA, 20195, US

(21) Appl. No.: 10/673,231

(22) Filed: Sep. 30, 2003

(30) Foreign Application Priority Data
Mar. 12, 2003 (DE) 10310797.5

(51) Int. Cl. G21F 1/00

(52) U.S. Cl. 250/515.1

(57) ABSTRACT

A device is for processing substrates, especially electrical circuit substrates. It includes a laser source, an optical deflection and mapping system arranged in the light path of the laser beam, and a glass guard shielding the optical system in the direction of the substrate. This glass guard is provided with a heating device with the result that it displays a noticeably higher temperature than its surroundings.

The present application hereby claims priority under 35 U.S.C. §119 on German patent application number DE 103 10797.5 filed Mar. 12, 2003, the entire contents of which are hereby incorporated herein by reference.

### FIELD OF THE INVENTION

The invention generally relates to a device for processing substrates, especially electrical circuit substrates, with a laser source, an optical deflection and mapping system arranged in the light path of the laser beam, and a glass guard shielding the optical system in the direction of the substrate.

### BACKGROUND OF THE INVENTION

For the purposes of processing printed circuit boards and similar circuit substrates, it is still customary to pattern metallic and dielectric layers with the aid of a laser beam or to cut through one or more layers with the laser beam. In this process, the material to be ablated is vaporized by the energy of the laser beam. It has been found, however, that this ablated material is deposited in the surroundings of the processing location in the form of dust particles; in particular, this material gives rise to contamination on the glass guard of the optical system.

It is admittedly a known and customary practice to remove this dust including ablated material from the processing location with the aid of extraction devices. In this process, however, only part of the undesirable dust is collected while the glass guard continues to be contaminated, which results in a considerable reduction in the laser energy arriving at the printed circuit board.

### SUMMARY OF THE INVENTION

An object of an embodiment of the invention is therefore to considerably reduce the contamination of the glass guard caused by deposits of material in a simple manner.

An object may be achieved according to an embodiment of the invention by the fact that the glass guard is provided with a heating device with the result that it displays a noticeably higher temperature than its surroundings.

An embodiment of the invention is based in the finding that the dust sublimated by the laser beam has the tendency to settle preferentially on colder surfaces. In seeking to reach thermal equilibrium, a heated glass guard plate also brings about a reduction in the relative air humidity in its immediate surroundings. Due to this drying effect, the adhesive forces of the dust on the surface of the glass guard are also reduced. This thermal effect is thus utilized for the purposes of keeping the glass guard plate clean.

The heating element arranged in front of the glass guard of the optical system can be designed in various ways. Thus, in an advantageous version, an annular heating element is provided which surrounds the glass guard all round and heats the latter from the outside inwards. Such an annular heating element can contain an electrical heating filament, for example.

But it is also possible to bring about the heating of the glass guard with the aid of a hot air blower which blows heated air against the underside of the glass guard with one or preferably a plurality of evenly distributed nozzles.

The temperature of the glass guard heated in this way should lie substantially above the normal ambient temperature, for example upwards of the order of approximately 50° C. The upper limit could lie at approximately 120° C. since the dust consisting of the plastic from the substrate melts or becomes sticky at higher temperatures, and surrounding plastic components could be damaged.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 shows a schematic view of a laser processing device according to an embodiment of the invention with a heated glass guard,

FIG. 2 shows a perspective view of the optical system in FIG. 1 from below,

FIG. 3 shows a graph of the laser power passing through the glass guard with and without heating as a function of the number of holes in a substrate.

### DETAILED DESCRIPTION OF THE PREFERRED EMBODIMENTS

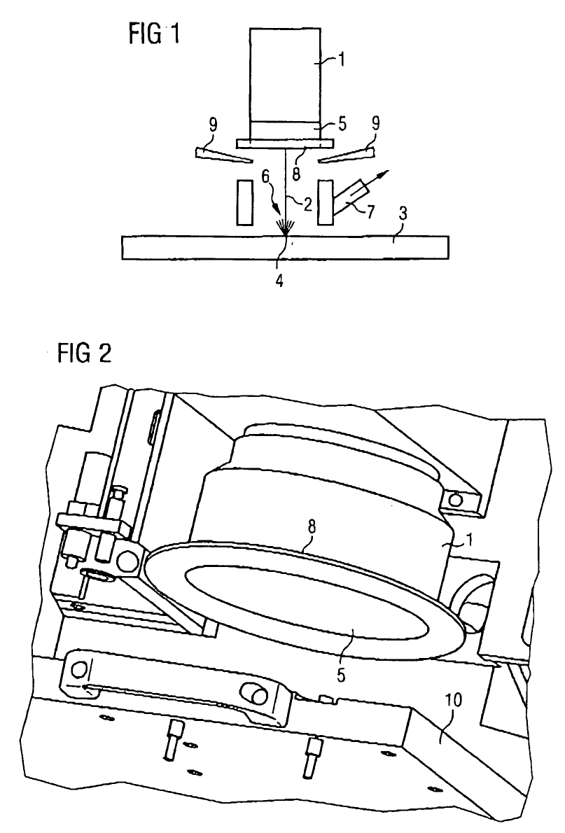

The laser processing system shown in schematic form in FIG. 1 possesses an optical system 1 by which a laser beam 2 is directed on to a printed circuit board 3. The optical system 1 preferably contains a lens system, while the upstream laser source itself and the deflection system required as a rule are not shown. A glass guard 5 is arranged between the optical system 1 and the processing location 4 on the printed circuit board in order to keep the mineral particles 6 sublimated from the printed circuit board away from the optical system 1. They are extracted to the outside partly via an extraction device 7.

In order to reduce the contamination of the glass guard 5, however, an annular heating element 8 is arranged on the latter. This, for example, sets the temperature of the glass guard noticeably higher than the ambient temperature with the aid of heating filaments. Additionally, hot air nozzles 9, which can bring about the heating of the glass guard in place of the annular heating element 8, are also shown in outline in FIG. 1.

FIG. 2 shows a perspective view, oriented obliquely from below, of the optical system 1 of the laser processing device with the glass guard 5 arranged at the lower end and the annular heating element 8. A processing table 10 can be seen below this on which the printed circuit board 3, which is not visible here, is positioned and fixed.

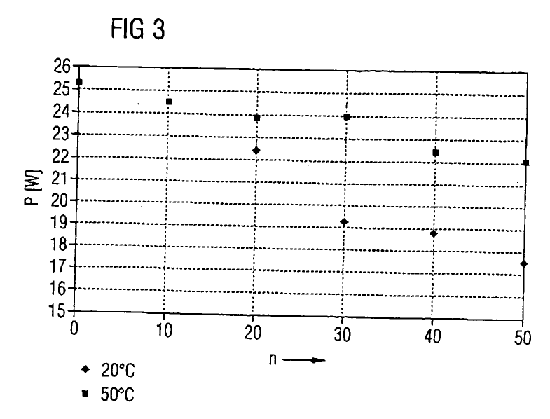

FIG. 3 shows measured results for the comparative measurement of the power of the laser beam reaching the printed circuit board through the glass guard. Each measurement was taken after a quantity n of operational cycles each with approximately 15,000 holes. In this respect, the power data for a glass guard with normal ambient temperature (20° C.) is represented as diamond-shaped points and the power data for heating of the glass guard to 50° C. as square points. It is clear that an improvement of approximately 20% in the useful laser power was achieved after 50 cycles. This result can presumably be improved even further given optimization of the heat supply.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for processing a substrate, comprising:
a laser source;
an optical deflection and mapping system arranged in a light path of the laser beam;
a glass guard shielding the optical system in the direction of the substrate, wherein the glass guard includes a heating device, adapted to heat at least a portion of the glass guard to a noticeably higher temperature than its surroundings.

2. A device as claimed in claim 1, wherein the heating device includes a heating element which encloses the glass guard in an annular manner.

3. A device as claimed in claim 1, wherein the heating device includes a hot air blower with at least one outlet nozzle directed at the glass guard.

4. A device as claimed in claim 3, wherein the blower includes a plurality of outlet nozzles distributed evenly around the periphery of the glass guard.

5. A device as claimed in claim 1, wherein the glass guard is adapted to be heated with the heating device to a temperature between approximately 50° C. and approximately 120° C.

6. A device as claimed in claim 1, further comprising an extraction device, arranged in a zone between the heating device and the substrate.

7. A device as claimed in claim 1, wherein the heating device includes an annular heating element.

8. A device as claimed in claim 1, wherein the heating device includes a hot air blower.

9. A device as claimed in claim 8, wherein the blower includes a plurality of outlet nozzles distributed evenly around the periphery of the glass guard.

10. A device as claimed in claim 2, wherein the glass guard is adapted to be heated with the heating device to a temperature between approximately 50° C. and approximately 120° C.

11. A device as claimed in claim 3, wherein the glass guard is adapted to be heated with the heating device to a temperature between approximately 50° C. and approximately 120° C.

12. A device as claimed in claim 8, wherein the glass guard is adapted to be heated with the heating device to a temperature between approximately 50° C. and approximately 120° C.

13. A device as claimed in claim 9, wherein the glass guard is adapted to be heated with the heating device to a temperature between approximately 50° C. and approximately 120° C.

14. A device as claimed in claim 2, further comprising an extraction device, arranged in a zone between the heating device and the substrate.

15. A device as claimed in claim 3, further comprising an extraction device, arranged in a zone between the heating device and the substrate.

16. A device as claimed in claim 8, further comprising an extraction device, arranged in a zone between the heating device and the substrate.

17. A device as claimed in claim 9, further comprising an extraction device, arranged in a zone between the heating device and the substrate.

18. A device as claimed in claim 5, further comprising an extraction device, arranged in a zone between the heating device and the substrate.

19. A device as claimed in claim 1, wherein the device is for processing electrical circuit substrates.

20. A device for processing a substrate, comprising:
a laser source;
an optical deflection system arranged in a light path of a laser beam; and
a glass guard, wherein the glass guard includes a heating device.

21. The device as claimed in claim 20, wherein the heating device is adapted to heat at least a portion of the glass guard to a relatively higher temperature than its surroundings.

22. The device as claimed in claim 20, wherein the heating device is adapted to heat at least a portion of the glass guard to a noticeably higher temperature than its surroundings.

23. A device as claimed in claim 20, wherein the heating device includes an annular heating element.

24. A device as claimed in claim 20, wherein the heating device includes a hot air blower.

25. A device as claimed in claim 24, wherein the blower includes a plurality of outlet nozzles distributed evenly around the periphery of the glass guard.

26. A device as claimed in claim 20, wherein the glass guard is adapted to be heated with the heating device to a temperature between approximately 50° C. and approximately 120° C.

27. A device as claimed in claim 21, wherein the glass guard is adapted to be heated with the heating device to a temperature between approximately 50° C. and approximately 120° C.

28. A device as claimed in claim 22, wherein the glass guard is adapted to be heated with the heating device to a temperature between approximately 50° C. and approximately 120° C.

29. A device for processing a substrate, comprising:
a laser source;
an optical deflection system arranged in a light path of a laser beam; and
a glass guard, wherein the glass guard includes heating means for heating at least a portion of the glass guard to a relatively higher temperature than its surroundings.

30. A device as claimed in claim 29, wherein the heating means includes an annular heating element.

31. A device as claimed in claim 29, wherein the heating means includes a hot air blower.

32. A device as claimed in claim 31, wherein the blower includes a plurality of outlet nozzles distributed evenly around the periphery of the glass guard.

33. A device as claimed in claim 29, wherein the glass guard is adapted to be heated with the heating device to a temperature between approximately 50° C. and approximately 120° C.
